(19) United States
(12) Patent Application Publication
(10) Pub. No.: US 2018/0244838 A1
(43) Pub. Date: Aug. 30, 2018

(54) POLYMER, OXIDIZED POLYMER, POLYMER COMPOSITION, GEL-TYPE POLYMER COMPOSITION, AND USE THEREOF

(71) Applicant: SOKEN CHEMICAL & ENGINEERING Co., Ltd., Tokyo (JP)

(72) Inventors: Takeshi MIYAMOTO, Saitama (JP); Shuji OKAMOTO, Saitama (JP); Fumiaki KOBAYASHI, Saitama (JP)

(73) Assignee: SOKEN CHEMICAL & ENGINEERING Co., Ltd., Tokyo (JP)

(21) Appl. No.: 15/562,293

(22) PCT Filed: Mar. 25, 2016
(86) PCT No.: PCT/JP2016/059627

§ 371 Date: Sep. 27, 2017

(30) Foreign Application Priority Data
Mar. 27, 2015 (JP) 2015-065747

(51) Int. Cl. C08G 61/12

(52) U.S. Cl. CPC C08G 61/126; C08G 2261/1424; C08G 2261/79; C08G 2261/45; C08G 2261/51; C08G 2261/3223

(57) ABSTRACT

Provided is a polymer having exceptional solubility in hydrophilic polar solvents and stability in solvents. The present invention provides a polymer containing one or two structural units selected from the group consisting of structural units represented by chemical formula (1) and chemical formula (2) (in formula (1) and formula (2), X1 and X2 may be the same or different, and represent H, an optionally substituted C1-12 alkyl group, an optionally substituted C1-12 alkoxy group, an optionally substituted C1-12 alkylene oxide group, an optionally substituted thiocyano group, an optionally substituted amino group, or an optionally substituted thioalkyl group, or an optionally substituted C1-12 alkylene dioxy group or optionally substituted C1-12 alkylene dithio group in which X1 and X2 are linked (excluding combinations in which both X1 and X2 are H or C1-12 alkyl groups and combinations in which one of X1 and X2 is H and the other is a C1-12 alkyl group); R represents a C1-12 alkyl group having an acidic substituent or a salt thereof, a C1-12 alkoxy group, a C1-12 alkylene oxide group having 1-50 repeating units, a phenyl group, a heterocyclic group, or a fused ring group).

### TECHNICAL FIELD

The present invention relates to a polymer, an oxidized polymer, a polymer composition, a gel polymer composition and uses thereof.

### BACKGROUND ART

There are many conventional technologies using a conductive polymer as a conductivity-imparting material usable for an antistatic agent, functional capacitor, transparent electrode material and the like, or as a hole transport material usable for an organic light emitting diode (OLED), organic photovoltaics (OPV), organic semiconductor sensor and the like. The conductive polymer is composed of a combination of a main skeleton which has a conjugated structure capable of electron transfer and a dopant for doping electrons or holes to the main skeleton. As a conductive main skeleton, a skeleton having a chemical structure with an expanded m electron conjugated system, e.g., a polymer such as 3,4-ethylenedioxythiophene (EDOT), pyrrole and aniline is generally used. As a dopant corresponding to it, there are various dopants such as inorganic Lewis acid and organic protonic acid. Among them, sulfonic acid compound is generally used as the organic protonic acid.

Among the conventional technologies related to the conductive polymer, it is known that a conductive polymer having the main skeleton polyaniline to which bis 2-ethylhexylsulfosuccinic acid is doped (for example, Patent Document 1), polyethylene dioxythiophene (PEDOT)/polystyrene sulfonic acid (PSS) having the main skeleton PEDOT to which PSS is doped, and the like.

In particular, there are many related technologies about PEDOT/PSS (for example, Patent Document 2) which is frequently used as a general material. PEDOT/PSS is used industrially since PEDOT used as the main skeleton is highly conductive, and PEDOT/PSS can have an excellent processing suitability in which a uniform film can be easily formed by the coating of its particles which are stably dispersed in water and have a small in-water diameter with nanometer order, by adjusting molecular weight or doping amount of PSS used as the dopant, undoped sulfonic acid concentration, or the like.

### PRIOR ART DOCUMENT

### Problem to be Solved by the Invention

Patent Document 1: Japanese Patent No. 3426637

Patent Document 2: Japanese Patent No. 2636968

### SUMMARY OF THE INVENTION

### Disclosure of the Invention

The present inventors have studied use of PEDOT/PSS in an aqueous solvent system. PEDOT/PSS appeared to be dissolved in water. However, in fact, particles are aggregated, and the solution is not completely homogeneous. From this result, the inventors found the problem that it is difficult to perform coating to a fine surface or fine filling by using PEDOT/PSS in the aqueous solvent.

The present invention has been made in view of the above circumstance, and provides a polymer having an excellent solubility in a hydrophilic polar solvent and an excellent stability in the solvent.

### Means for Solving the Problem

According to the present invention, there is provided that a polymer including one or two structural units selected from the group consisting of a structural unit represented by the following chemical formula (1) and a structural unit represented by the following chemical formula (2):

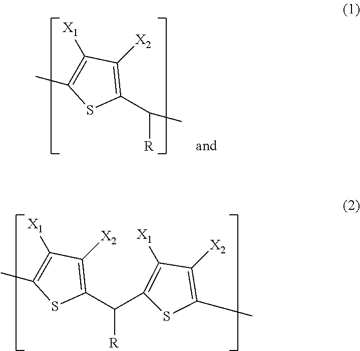

wherein X1 and X2 may be the same as or different from each other,

wherein X1 and X2 represent:
H;
an alkyl group having 1 to 12 carbon atoms, optionally having a substituent;
an alkoxy group having 1 to 12 carbon atoms, optionally having a substituent;
an alkylene oxide group having 1 to 12 carbon atoms, optionally having a substituent;
a thiocyano group optionally having a substituent;
an amino group optionally having a substituent; or
a thioalkyl group optionally having a substituent, or

X1 and X2 are combined to be an alkylenedioxy group having 1 to 12 carbon atoms, optionally having a substituent, or an alkylenedithio group having 1 to 12 carbon atoms, optionally having a substituent,

wherein X1 and X2 are not any of combinations of both X 1 and X 2 being H, of both X 1 and X 2 being the alkyl group having 1 to 12 carbon atoms, and of one of X 1 and X 2 being H with the other being the alkyl group having 1 to 12 carbon atoms, and

wherein R represents:
an alkyl group having 1 to 12 carbon atoms;
an alkoxy group having 1 to 12 carbon atoms;
an alkylene oxide group having 1 to 20 carbon atoms and 1 to 50 repeating units;
a phenyl group;
a heterocyclic group; or
a condensed ring group, having an acidic substituent or a salt thereof.

The present inventors studied on a polymer having an excellent solubility in a hydrophilic polar solvent, and found that, by introducing an acidic substituent into a main chain of a polymer, it can be dissolved in the hydrophilic polar solvent.

The present inventors also found that it has extremely higher impregnating ability to a porous body since it has the excellent stability in the solvent and forms a uniform solution when dissolved in the solvent.

In addition, the inventors found that when a basic additive is added to a solution of the polymer having the acidic substituent, its stability is improved and its corrosivity is reduced. Furthermore, the inventors found that, by oxidizing the polymer having the acidic substituent, higher conductivity is exhibited even in the state where the base additive is added. The inventors also found that it can also be used as a gel electrolyte by addition of a gelling agent. The present invention has been completed based on the findings.

Various embodiments of the present invention will be exemplified as follows. The following embodiments may be combined with each other.

Preferably, X1 and X2 may be the same as or different from each other, and X1 and X2 are:

the alkoxy group having 1 to 12 carbon atoms, optionally having the substituent; or
the alkylene oxide group having 1 to 12 carbon atoms, optionally having the substituent, or
X1 and X2 are combined to be the alkylenedioxy group having 1 to 12 carbon atoms, optionally having the substituent.

Preferably, R is the alkyl group having 1 to 12 carbon atoms and the acidic substituent or the salt thereof, the alkoxy group having 1 to 12 carbon atoms, or the phenyl group.

Preferably, the acidic substituent or the salt thereof is a sulfo group or an alkali metal salt thereof, or a phosphoric acid group or an alkali metal salt thereof.

Preferably, there is provided an oxidized polymer being an oxide of the polymer.

Preferably, there is provided a polymer composition including the polymer or the oxidized polymer and a solvent.

Preferably, there is provided a polymer composition comprising the polymer composition and a base additive.

Preferably, a polymer composition obtained by drying the polymer composition.

Preferably, a gel polymer composition obtained by adding a gelling agent to the polymer composition.

### DETAILED DESCRIPTION OF THE INVENTION

An embodiment of the present invention will be described in detail.

The present invention relates to a polymer including one or two structural units selected from the group consisting of a structural unit represented by the following chemical formula (1) and a structural unit represented by the following chemical formula (2). This polymer is can be used as a conductive polymer as an example, but is not limited thereto.

Firstly, a method for synthesizing a polymer usable as a conductive polymer will be described. Secondly, a method for preparing a polymer composition as an example of the conductive polymer will be described.

### <Polymer>

A polymer of the present invention includes one or two structural units selected from the group consisting of the structural unit represented by the following chemical formula (1) and the structural unit represented by the following chemical formula (2).

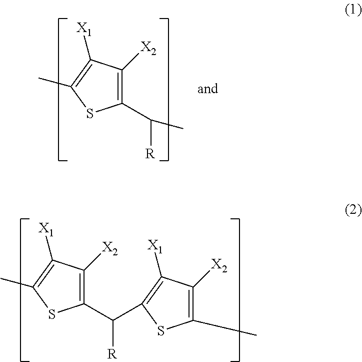

wherein X1 and X2 may be the same as or different from each other,

wherein X1 and X2 represent:
H;
an alkyl group having 1 to 12 carbon atoms, optionally having a substituent;
an alkoxy group having 1 to 12 carbon atoms, optionally having a substituent;
an alkylene oxide group having 1 to 12 carbon atoms, optionally having a substituent;
a thiocyano group optionally having a substituent;
an amino group optionally having a substituent; or
a thioalkyl group optionally having a substituent, or

X1 and X2 are combined to be an alkylenedioxy group having 1 to 12 carbon atoms, optionally having a substituent, or an alkylenedithio group having 1 to 12 carbon atoms, optionally having a substituent,

wherein X1 and X2 are not any of combinations of both X1 and X2 being H, of both X1 and X2 being the alkyl group having 1 to 12 carbon atoms, and of one of X1 and X2 being H with the other being the alkyl group having 1 to 12 carbon atoms, and

wherein R represents:
an alkyl group having 1 to 12 carbon atoms;
an alkoxy group having 1 to 12 carbon atoms;
an alkylene oxide group having 1 to 20 carbon atoms and 1 to 50 repeating units;
a phenyl group;
a heterocyclic group; or
a condensed ring group, having an acidic substituent or a salt thereof.

At least one of X1 and X2 preferably has an electron-donating group directly bonded to a heterocycle.

In X1 and X2, no limitation is applied to a substituent from the alkyl group having 1 to 12 carbon atoms, optionally having the substituent; the alkoxy group having 1 to 12 carbon atoms, optionally having the substituent; the alkylene oxide group having 1 to 12 carbon atoms, optionally having the substituent; the thiocyano group optionally having the substituent; the amino group optionally having the substituent; the thioalkyl group optionally having the substituent; the alkylenedioxy group to which X1 and X2 are combined, having 1 to 12 carbon atoms and optionally having the substituent; or the alkylenedithio group to which X1 and X2 are combined, having 1 to 12 carbon atoms and optionally having the substituent. Preferably, the substituent does not relatively inhibit an electron donating property relative to the heterocycle, specifically, may be a straight chain, branched or cyclic alkyl group, a sulfo group, a hydroxyl group, a carboxyl group, an amino group, an amide group, an ester group and a straight chain, branched or cyclic alkyl group, alkoxy alkyl group, alkylene oxide group substituted for the sulfo group, hydroxyl group, carboxyl group, amino group, halogen group, and may have a plurality of the substituents.

The number of carbons of the straight chain, branched, or cyclic alkyl group, the carboxyl group, the amide group, the ester group, the alkoxyalkyl group or the alkylene oxide group as the substituent is, for example, 1 to 20, preferably 1 to 12, but not limited thereto. Specifically, the number of the carbons is, for example, 1, 2, 3, 4, 5, 6, 7, 8, 9, 10, 11, 12, 13, 14, 15, 16, 18 or 20, and may be within a range between any two of the values exemplified above.

Although one of X1 and X2 may be hydrogen or the alkyl group having 1 to 12 carbon atoms, optionally having the substituent, it is preferable to exclude combinations of both X1 and X2 being the alkyl groups, both X1 and X2 being hydrogen, and one of X1 and X2 being hydrogen with the other being the alkyl group.

In X1 and X2, the alkylenedioxy group having 1 to 12 carbon atoms, optionally having the substituent and the alkylenedithio group having 1 to 12 carbon atoms, optionally having the substituent may have an oxygen analog, nitrogen analog, or sulfur analog structure instead of an ethylene structure in a main chain of the alkylene.

The acidic substituent of R or the salt thereof is a sulfo group or an alkali metal salt thereof, or a phosphoric acid group or an alkali metal salt thereof, preferably the sulfo group or the alkali metal salt thereof.

The heterocyclic group includes, for example, a monovalent group derived from a silole ring, a furan ring, a thiophene ring, an oxazole ring, a pyrrole ring, a pyridine ring, a pyridazine ring, a pyrimidine ring, a pyrazine ring, a triazine ring, an oxadiazole ring, a triazole ring, an imidazole ring, a pyrazole ring, a thiazole ring, an indole ring, a benzimidazole ring, a benzthiazole ring, a benzoxazole ring, a quinoxaline ring, a quinazoline ring, a phthalazine ring, a thieno thiophene ring, a carbazole ring, an azacarbazole ring (in which any one or more carbon atoms constituting the carbazole ring is replaced with a nitrogen atom), a dibenzosilole ring, a dibenzofuran ring, a dibenzothiophene ring, a ring in which any one or more carbon atoms constituting the benzothiophene ring or the dibenzofuran ring is replaced by a nitrogen atom, a benzodifuran ring, a benzodithiophene ring, an acridine ring, a benzoquinoline ring, a phenazine ring, a phenanthridine ring, a phenanthroline ring, a cyclazine ring, a kindrin ring, a tepenidine ring, a quinindoline ring, a triphenodithiazine ring, a triphenodioxazine ring, a phenanthrazine ring, an anthrazine ring, a perimidine ring, a naphthofuran ring, a naphthothiophene ring, a naphthodifuran ring, a naphthodithiophene ring, an anthrafuran ring, an anthrafudaran ring, an anthrathiophene ring, an anthradithiophene ring, a thianthrene ring, a phenoxathiin ring, a dibenzo carbazole ring, a indolocarbazole ring, a dithienobenzene ring, an epoxy ring, an aziridine ring, a thiirane ring, an oxetane ring, an azetidine ring, a thietane ring, a tetrahydrofuran ring, a dioxolane ring, a pyrrolidine ring, a pyrazolidine ring, an imidazolidine ring, an oxazolidine ring, a tetrahydrothiophene ring, a sulfolane ring, a thiazolidine ring, a ε-caprolactone ring, a ε-caprolactam ring, a piperidine ring, a hexahydropyridazine ring, a hexahydropyrimidine ring, a piperazine ring, a morpholine ring, a tetrahydropyran ring, a 1,3-dioxane ring, a 1,4-dioxane ring, a trioxane ring, a tetrahydrothiopyran ring, a thiomorpholine ring, a thiomorpholine-1,1-dioxide ring, a pyranose ring, a diazabicyclo [2,2,2] -octane ring, a phenoxazine ring, a phenothiazine ring, an oxanthrene ring, a thioxanthene ring or a phenoxathiin ring, and the like.

The condensed ring includes, for example, a naphthalene ring, an azulene ring, an anthracene ring, a phenanthrene ring, a pyrene ring, a chrysene ring, a naphthacene ring, a triphenylene ring, an acenaphthene ring, a coronene ring, a fluorene ring, a fluorantrene ring, a pentacene ring, a perylene ring, a pentaphene ring, a pyranthrene ring, and the like.

The alkyl group having 1 to 12 carbon atoms, the alkoxy group having 1 to 12 carbon atoms, the alkylene oxide group having 1 to 20 carbon atoms and 1 to 50 repeating units, the phenyl group, the heterocyclic group or the condensed ring group of R may have an optional substituent at any positions in addition to the acidic substituent or the salt thereof.

The optional substituent includes, for example, an alkyl group having 1 to 12 carbon atoms, an alkoxy group having 1 to 12 carbon atoms, an alkylene oxide group having 1 to 20 carbon atoms and 1 to 50 repeating units, a phenyl group, a naphthyl group, a hydroxyl group, an aldehyde group, an amino group, a cycloalkyl group having 3 to 8 carbon atoms, and the like.

### <Synthesis of Polymer>

The polymer represented by the chemical formulae (1) and (2) are obtained by polymerizing a heterocyclic compound of the chemical formula (3) and an aldehyde derivative of the chemical formula (4).

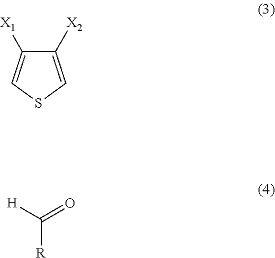

(X1 and X2 in the formula (3) and R in the formula (4) are the same as X1, X2 and R in the chemical formulae (1) and (2), respectively.)

The heterocyclic compound of the chemical formula (3) can be mainly divided into two kinds of the following chemical formulae (3-A) and (3-B).

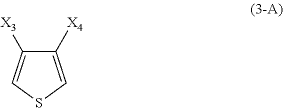

(in the formula (3-A), X3 and X4 may be the same as or different from each other, and represent: H; an alkyl group having 1 to 12 carbon atoms, optionally having a substituent; an alkoxy group having 1 to 12 carbon atoms, optionally having a substituent; an alkylene oxide group having 1 to 12 carbon atoms, optionally having a substituent; a thiocyano group optionally having a substituent; an amino group optionally having a substituent; or a thioalkyl group optionally having a substituent. In addition, X3 and X4 are not any of combinations of both X1 and X2 being H, of both X1 and X2 being the alkyl group having 1 to 12 carbon atoms, and of one of X1 and X2 being H with the other being the alkyl group having 1 to 12 carbon atoms.

Although, in X3 and X4, no limitation is applied to a substituent from: the alkyl group having 1 to 12 carbon atoms, optionally having the substituent; the alkoxy group having 1 to 12 carbon atoms, optionally having the substituent; the alkylene oxide group having 1 to 12 carbon atoms, optionally having the substituent; the thiocyano group optionally having the substituent; the amino group optionally having the substituent; or the thioalkyl group optionally having the substituent, the substituent may be the same as the substituents of X1 and X2.

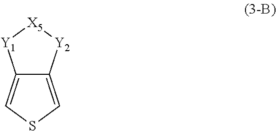

(in the formula (3-B), Y1 and Y2 represent an oxygen atom or a sulfur atom, and X5 is an alkylene group having 1 to 12 carbon atoms, optionally having a substituent and may have an oxygen analog, nitrogen analog, and sulfur analog structure instead of an ethylene structure in a main chain of the alkylene.)

Although no limitation is applied to the substituent from the alkylene group having 1 to 12 carbon atoms, optionally having the substituent in X5 may be the same as the substituents of X1 and X2.

The aldehyde derivative of the chemical formula (4) can be mainly divided into two kinds of chemical formulae (4-A) and (4-B).

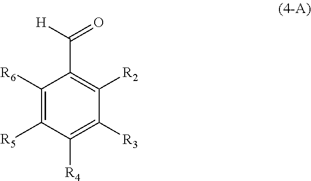

(in the formula (4-A), at least one of R2 to R6 has the acidic substituent or the salt thereof, and R2 to R6 may have a plurality of an alkyl group having 1 to 12 carbon atoms, an alkoxy group having 1 to 12 carbon atoms, an alkylene oxide group having 1 to 20 carbon atoms and 1 to 50 repeating units, an alkylene oxide group having 1 to 12 carbon atoms, a phenyl group, a naphthyl group, a hydroxyl group, an aldehyde group, an amino group, or a cycloalkyl group having 3 to 8 carbon atoms.)

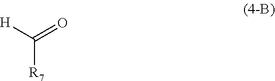

(in the formula (4-B), R7 represents an alkyl group having 1 to 12 carbon atoms, an alkoxy group having 1 to 12 carbon atoms, alkylene oxide group having 1 to 20 carbon atoms and 1 to 50 repeating units, heterocyclic group and condensed ring group, having an acidic substituent or a salt thereof, and may have an optional substituent at any positions.)

### <Polymerization Reaction>

Predetermined amounts of the heterocyclic compound, the aldehyde derivative, a polymerization reaction solvent and an acid are added to a reaction vessel, and then heating and stirring are performed with inert gas enclosed. After the reaction, a reaction termination step and a purification step are carried out to obtain a polymer.

The reaction vessel can be made of glass, Teflon®, or the like, but is not particularly limited thereto.

As long as the polymerization reaction of the heterocyclic compound and the aldehyde derivative proceeds, the polymerization reaction solvent includes any solvent such as ethyl acetate, tetrahydrofuran, tert-butyl methyl ether, acetonitrile, but is not particularly limited thereto.

As long as the polymerization reaction of the heterocyclic compound and the aldehyde derivative proceeds, the acid includes any acid such as perchloric acid, sulfuric acid, methanesulfonic acid, trifluoroacetic acid and p-toluenesulfonic acid, but is not particularly limited thereto.

The inert gas includes, for example, nitrogen, argon and helium.

The stirring method may be based on use of a stirrer or a shaking machine, but is not particularly limited thereto.

A stirring temperature during the polymerization reaction is 25° C. to 100° C., preferably 40° C. to 80° C. Specifically, this temperature is, for example, 25, 30, 40, 50, 60, 70, 80, 90 or 100° C. and may be within a range between any two of the values exemplified above.

A stirring time during the polymerization reaction is, for example, 1 to 12 hours, preferably 5 to 9 hours, but is not particularly limited thereto. Specifically, this time is, for example, 1, 2, 3, 4, 5, 6, 7, 8, 9, 10, 11 or 12 hours, and within a range between any two of the values exemplified above.

As long as the polymerization reaction can be stopped, the reaction termination step may be performed by a known method, specifically, a cooling method based on the addition of methanol, ethanol, water or the like.

As long as the polymer can be isolated, the purification step may be performed by a known method, specifically, a method for precipitating the polymer by adding a large amount of a solvent which the polymer is not dissolved, and then filtrating, washing and recrystallizing the precipitate.

The polymer having either a single structure or a mixed structure of a structural unit represented by the chemical formula (1) and a structural unit represented by the chemical formula (2) can be synthesized by the above synthesis method of the polymer.

Specifically, the proportion of the structural unit represented by the chemical formula (2) can be increased by increasing an amount of the heterocyclic compound to be used over that of the aldehyde derivative.

The proportion of the structural unit of the chemical formula (1) or the structural unit of the chemical formula (2) of the polymer is 0 to 100, preferably 10 to 90, but is not particularly limited thereto. Specifically, the proportion is, for example, 0, 10, 20, 30, 40, 50, 60, 70, 80, 90, 100, and may be within a range between any two of the values exemplified above. The above proportion may be expressed by weight % or mol %.

The number of the repeating units including the structural units of the chemical formula (1) and the chemical formula (2) in the polymer is 2 to 100, preferably 2 to 20, but is not particularly limited thereto. Specifically, the number is for example, 2, 5, 10, 20, 30, 40, 50, 60, 70, 80, 90 or 100, and may be within a range between any two of the values exemplified above.

### <Synthesis of Oxidized Polymer>

Predetermined amounts of the polymer and an oxidation reaction solvent are added to the reaction vessel, and inert gas replacement is performed, an oxidizing agent is added and then stirring is performed. After the reaction, a purification step is carried out to obtain an oxidized polymer.

The reaction vessel, the inert gas, and the stirring method may be the same as those of the polymerization reaction, but is not particularly limited thereto.

As long as the oxidation reaction proceeds, the oxidation reaction solvent may be any solvents such as water and alcohol solvents (e.g., methanol, ethanol, isopropyl alcohol, and butanol), but is not particularly limited thereto.

As long as the oxidizing reaction proceeds, the oxidizing agent may be any acid such as peroxide (e.g., ammonium peroxodisulfate (APS), sodium persulfate and potassium persulfate), hydrogen peroxide, quinone (e.g., p-benzoquinone and chloranil), iron (III) chloride, iron (III) sulfate, iron (III) hydroxide, iron (III) tetrafluoroborate, iron (III) hexafluorophosphate, copper (II) sulfate, copper (II) chloride, copper (II) tetrafluoroborate and copper (II) hexafluorophosphate, but is not particularly limited thereto.

A stirring temperature during the oxidation reaction is 0° C. to 50° C., preferably 10° C. to 30° C. Specifically, this temperature is, for example, 0, 10, 20, 30, 40, 50° C. and may be within a range between any two of the values exemplified above.

A stirring time during the oxidation reaction is, for example, 1 to 12 hours, preferably 1 to 5 hours, but is not particularly limited thereto. Specifically, this time is, for example, 1, 2, 3, 4, 5, 6, 7, 8, 9, 10, 11 or 12 hours, and may be within a range between any two of the values exemplified above.

As long as the polymer can be isolated, the purification step may be performed by a known method, specifically, a method having a removing step of ionic components through an ion exchange resin and a lyophilizing step.

The polymer cannot obtain conductivity under heating condition. However, the oxidized polymer can obtain the conductivity even under the heating condition.

### <Preparation of Polymer Composition>

The polymer or the oxidized polymer is added to a solvent and stirred to obtain a polymer composition.

The solvent is any solvents in which the polymer or the oxidized polymer can be dissolved and dispersed, for example, water, dimethylsulfoxide, an alcohol-based solvent such as methanol, ethanol and isopropyl alcohol, a glycol-based solvent such as methyl cellosolve, ethyl cellosolve, propylene glycol methyl ether, propylene glycol ethyl ether and ethylene glycol, and a hydrophilic polar solvent such as gamma-butyrolactone and dioxane, acetonitrile, but is not particularly limited thereto.

The stirring method may be based on the use of the stirrer or the shaker, but is not particularly limited thereto.

A stirring time during the preparation of the polymer composition is, for example, 1 to 12 hours, preferably 1 to 5 hours, but is not particularly limited thereto. Specifically, this time is, for example, 1, 2, 3, 4, 5, 6, 7, 8, 9, 10, 11 or 12 hours, and may be within a range between any two of the values exemplified above.

An amount of the solvent to be used for preparing the polymer composition is set to, for example, the amount such that a solid content is 1% to 20%, preferably 1% to 10%, but is not particularly limited thereto. Specifically, this value is, for example, 1, 2, 3, 4, 5, 6, 7, 8, 9, 10, 12, 14, 16, 18 or 20%, and may be within a range between any two of the values exemplified above.

In addition, by neutralizing the polymer composition with a base additive, it is possible to obtain a polymer composition having improved stability and reduced corrosiveness.

The base additive is any base additives capable of neutralizing the polymer composition, for example, an organic base or an inorganic base having a pKa of 9 or more as a conjugate acid in water, e.g., an amine such as ammonia, triethylamine and ethanolamine, and an alkali metal hydroxide or an alkaline earth metal hydroxide such as sodium hydroxide, potassium hydroxide and calcium hydroxide, preferably an amine having the pKa of 9 or more as the conjugate acid in water such as ammonia, trimethylamine and ethanolamine, but is not particularly limited thereto. In particular, the amine is excellent in solvent solubility and corrosiveness-reducing effect.

When dried, the polymer composition can be used as, for example, a conductive polymer. In an example, a uniform film can be made from the polymer composition when coated.

As a drying method may be a known drying method, but is not particularly limited thereto.

### <Preparation of Gel Polymer Composition>

Predetermined amounts of the polymer composition and a gelling agent are added to a reaction vessel and heated to dissolve the gelling agent. Thereafter, the mixture is cooled and then obtain a gel polymer composition.

The reaction vessel may be the same as one used in the polymerization reaction, but is not particularly limited thereto.

The gelling agent may be any gelling agents capable of forming the gel polymer composition, for example, a polymer such as polyethylene oxide, polyvinyl alcohol, polyacrylamide, polyvinyl pyrrolidone and polyvinyl butyral, gelatin, pectin, starch, and a polymer such as polyvinyl pyridine and polymethacrylate used in combination with a diamine-based crosslinking agent, which swell by absorbing the solvent, but is not particularly limited thereto.

A heating temperature for preparing the gel polymer composition is 25° C. to 100° C., preferably 40° C. to 80° C. Specifically, this temperature is, for example, 25, 30, 40, 50, 60, 70, 80, 90 or 100° C., and may be within a range between any two of the values exemplified above.

A heating time for preparing the gel polymer composition is, for example, 1 to 12 hours, preferably 1 to 5 hours, but is not particularly limited thereto. Specifically, this time is, for example, 1, 2, 3, 4, 5, 6, 7, 8, 9, 10, 11 or 12 hours, and may be within a range between any two of the values exemplified above.

During the preparation of the gel polymer composition, the heating may be carried out with the stirring.

Since the polymer of the present invention is a self-doped polymer, a polymer having a small particle size can be obtained.

Furthermore, since it has higher solubility in the hydrophilic polar solvent, has very higher impregnating ability to a porous body such as a metal sintered body, and can perform fine filling or coating to a fine surface, it can also be used as the gel polymer composition by adding the gelling agent.

The polymer, oxidized polymer, polymer composition and gel polymer composition of the present invention can be suitably used for applications in fields where miniaturization is progressing, such as a antistatic agent for various applications and antistatic film using thereof, a p-type organic semiconductor, a n-type organic semiconductor, a solid electrolyte of a solid electrolytic capacitor and additive thereof, an electrochromic device, a transparent electrode of an organic photovoltaic, a counter electrode of a dye-sensitized solar cell and its adjuvant, an organic electroluminescence, a chemical sensor, a fuel cell, an electronic device such as a touch panel and a liquid crystal display, a pressure sensitive adhesive, and an additive to carbon, but is not particularly limited thereto.

### EXAMPLE

### Synthesis of Polymer

### Synthesis Example 1: Synthesis of Polymer 1

80 g EDOT, 48 g sodium 2-sulfobenzaldehyde, 60 g ethyl acetate and 1.5 g tetrafluoroacetic acid were added to 300 ml reaction vessel, and heated to 50° C. with stirring under nitrogen substitution. After the reaction for 7 hours, 10 g methanol was added and cooled. After transferring the reaction solution to 500 ml container, 200 g ethyl acetate was added and stirred. Thereafter, precipitate was collected by filtration. Crystals were collected, and then dissolved in methanol/water=90/10 to remove insoluble matter. The solution was recrystallized to obtain Polymer 1 of green crystals. Polymer 1 obtained in Synthesis Example 1 had structures of both chemical formulae (1) and (2).

### Synthesis Example 2: Synthesis of Polymer 2

Polymer 1 was dissolved in ion-exchanged water such that a solid content is 2.2%. After removing Na using an ion exchange resin, lyophilization was performed to obtain Polymer 2 of green crystal.

### Synthesis Example 3: Synthesis of Polymer 3 (Oxidized Polymer)

4.0 g Polymer 1 and 100 g ion-exchanged water were added to 300 ml flask. The atmosphere in the flask was sufficiently substituted with nitrogen. In addition, 1.0 g of APS (ammonium peroxodisulfate) was added and stirred at 25° C. for 3 hours. After treating the solution with an excess of the ion exchange resin, the lyophilization was performed to obtain Polymer 3 of blue-violet crystal.

### Synthesis Example 4: Synthesis of Polymer 4

3.53 g EDOT (3,4-ethylenedioxythiophene) and 25 g ion-exchanged water were added to 300 ml flask. The atmosphere in the flask was sufficiently substituted with nitrogen. 15.2 g of 40 wt % aqueous solution of 4-formyl-1,3-disulfobenzene was added and the mixture was stirred at 50° C. for 2.5 hours. After adding 125 g ion-exchanged water, 3.6 g APS and 10 g ion-exchanged water were added, and the mixture was stirred at room temperature for 5 hours. After treatment with an excess of the ion exchange resin, the lyophilization was performed to obtain Polymer 4 of blue crystal. Polymer 4 obtained in Synthesis Example 4 had structures of both chemical formula (1) and chemical formula (2).

### Synthesis Example 5: Synthesis of Polymer 5

14.2 g EDOT, 5.6 g benzaldehyde and 50 g MEK (methyl ethyl ketone) were added to 300 ml flask. The atmosphere in the flask was sufficiently substituted with nitrogen. 0.2 g concentrated sulfuric acid was added, and the mixture was stirred at 50° C. for 2.5 hours. 100 g ion-exchanged water was added, 14.5 g benzoyl peroxide and 20 g MEK were added, and the mixture was further stirred at room temperature for 5 hours. After treatment with an excess of the ion exchange resin, vacuum distillation was performed with an evaporator to obtain Polymer 5 of brown crystal.

### Synthesis Example 6: Synthesis of Polymer 6

16 g polystyrene sulfonic acid aqueous solution (Mw: 75,000, solid content: 19%), 0.1 g iron (III) sulfate n-hydrate and 200 g ion-exchanged water were added to 300 ml flask. The atmosphere in the flask was sufficiently substituted with nitrogen. 1.2 g EDOT, 2.3 g APS and 30 g ion-exchanged water were added and stirred at 25° C. for 5 hours. After treatment with an excess of the ion exchange resin, the lyophilization was performed to obtain Polymer 6 of blue crystal.

### Preparation of Polymer Composition

### Preparation Example 1 (without Base Additive): Preparation of Polymer Compositions 1, 3, 5 and 7

The ion-exchanged water, DMSO (dimethylsulfoxide), EG (ethylene glycol), γBL (gamma butyrolactone) were added to Polymer 1 prepared in Synthesis Example 1 and stirred for 1 hour to obtain Polymer Compositions 1, 3, 5 and 7 having 2.0% solid content.

### Preparation Example 2 (with Base Addition): Preparation of Polymer Compositions 2, 4, 6, 8

Polymer compositions 1, 3, 5 and 7 were neutralized by addition of 20 wt % aqueous ammonia solution to obtain Polymer Compositions 2, 4, 6 and 8.

### Preparation of Polymer Compositions 9 to 32

Polymer Compositions 9 to 32 were obtained in the same manner as Preparation Examples 1 and 2, except that Polymer 1 was changed to Polymers 2 to 4.

### Preparation Example 3 (without Base Additive): Preparation of Polymer Composition 33 (Comparative Example)

The ion-exchanged water was added to Polymer 5 prepared in Synthesis Example 5, and the mixture was strongly dispersed using an ultrasonic homogenizer to obtain Polymer Composition 33.

### Preparation Example 4 (with Base Additive): Preparation of Polymer Composition 34 (Comparative Example)

Polymer composition 33 was neutralized by the addition of 20 wt % aqueous ammonia solution to Polymer Composition 34.

### Preparation Example 5 (without Base Additive): Preparation of Polymer Composition 35 (Comparative Example)

DMSO was added to Polymer 5 prepared in Synthesis Example 5 and stirred for a certain period to obtain Polymer Composition 35 having 2.0% solid content.

### Preparation Example 6 (with Base Additive): Preparation of Polymer Composition 36 (Comparative Example)

Polymer Composition 35 was neutralized by the addition of 20 wt % aqueous ammonia solution to obtain Polymer Composition 36.

### Preparation of Polymer Compositions 37 to 44 (Comparative Example)

Polymer Compositions 37 to 44 were obtained in the same manner as Preparation Examples 1 and 2, except that Polymer 1 was changed to Polymer 6.

### Preparation Example 7 (without Base Additive): Preparation of Polymer Composition 45 (Comparative Example)

A powder obtained by lyophilizing polystyrene sulfonic acid (Mw: 75,000, nonvolatile content: 19%) was added to ethylene glycol to obtain a solution having 1.3% solid content.

### Preparation Example 8 (with Base Addition): Preparation of Polymer Composition 46 (Comparative Example)

Polymer Composition 45 was neutralized by addition of 20 wt % aqueous ammonia solution to obtain Polymer Composition 47.

### Preparation Example 9: Preparation of Gel Polymer Composition 1

10 g Polymer Composition 25 and 1.4 g gelatin were added to 100 ml flask and heated to 50° C. to completely dissolve the gelatin. This was allowed to stand at 25° C. to obtain Gel Polymer Composition 1.

### Preparation of Gel Polymer Composition 2 (Comparative Example)

Gel Polymer Composition 2 was obtained in the same manner as Preparation Example 9 except that Polymer Composition 25 was changed to Polymer Composition 45.

Table 1 shows combinations of Polymer Compositions.

TABLE 1

| | Polymer Composition | | | | | | | |
|---|---|---|---|---|---|---|---|---|
| | 1 | 2 | 3 | 4 | 5 | 6 | 7 | 8 |
| Polymer | Polymer 1 | | | | | | | |
| Solvent | Ion-Exchanged | | DMSO | | EG | | γBL | |
| | Water | | | | | | | |
| Base Additive | — | NH₃ | — | NH₃ | — | NH₃ | — | NH₃ |
| | Polymer Composition | | | | | | | |
| | 9 | 10 | 11 | 12 | 13 | 14 | 15 | 16 |
| Polymer | Polymer 2 | | | | | | | |
| Solvent | Ion-Exchanged | | DMSO | | EG | | γBL | |
| | Water | | | | | | | |
| Base Additive | — | NH₃ | — | NH₃ | — | NH₃ | — | NH₃ |
| | Polymer Composition | | | | | | | |
| | 17 | 18 | 19 | 20 | 21 | 22 | 23 | 24 |
| Polymer | Polymer 3 | | | | | | | |
| Solvent | Ion-Exchanged | | DMSO | | EG | | γBL | |
| | Water | | | | | | | |
| Base Additive | — | NH₃ | — | NH₃ | — | NH₃ | — | NH₃ |
| | Polymer Composition | | | | | | | |
| | 25 | 26 | 27 | 28 | 29 | 30 | 31 | 32 |
| Polymer | Polymer 4 | | | | | | | |
| Solvent | Ion-Exchanged | | DMSO | | EG | | γBL | |
| | Water | | | | | | | |
| Base Additive | — | NH₃ | — | NH₃ | — | NH₃ | — | NH₃ |

Polymer Composition

| | | | |
|---|---|---|---|
| 33 | 34 | 35 | 36 |

| Polymer | Polymer 5 | |
|---|---|---|
| Solvent | Ion-Exchanged | DMSO |
| | Water | |

| | | | | |
|---|---|---|---|---|
| Base Additive | — | NH₃ | — | NH₃ |

| | Polymer Composition | | | | | | | |
|---|---|---|---|---|---|---|---|---|
| | 37 | 38 | 39 | 40 | 41 | 42 | 43 | 44 |
| Polymer | Polymer 6 | | | | | | | |
| Solvent | Ion-Exchanged | | DMSO | | EG | | γBL | |
| | Water | | | | | | | |
| Base Additive | — | NH₃ | — | NH₃ | — | NH₃ | — | NH₃ |

Polymer Composition

| | |
|---|---|
| 45 | 46 |

| | |
|---|---|
| Polymer | PSS |
| Solvent | EG |

| | | |
|---|---|---|
| Base Additive | — | NH₃ |

### <Method for Evaluating Solution Stability>

8 g Polymer Compositions 1 to 44 immediately after preparation were added to respective 10 ml containers. Each container was sealed and allowed to stand, and the presence or absence of precipitate in each container was observed. “Excellent” means a case where there was no precipitate for one or more weeks, “Good” means a case where there was no precipitate for one or more days, and “Bad” means a case where the precipitate occurs less than one day.

### <Method for Evaluating Solvent Solubility>

10 ml Polymer Compositions 1 to 44 were filtered with TOMSIC membrane filters (membrane PTFE, size: 30 mm, pore size: 0.45 μm), and respective liquid passable amounts were measured. “Excellent” means a case where the liquid passable amount is all 10 ml, “Good” means a case where the liquid passable amount is 5 ml or more, and “Bad” means a case where the liquid passable amount is less than 5 ml.

### <Method for Evaluating Impregnation Property>

10 g Polymer Compositions 1 to 44 were added to respective 100 ml containers, followed by the addition of 1 g activated alumina (KHO-24, manufactured by Sumitomo Chemical Co., Ltd.). After leaving for 30 minutes, the activated alumina in each container was removed and drying was performed at 105° C. for 30 minutes. The activated alumina impregnated with resin was divided in half, the cross-section thereof was observed with a CCD, and depth of the impregnation was measured.

“Excellent” means a case where the depth of the impregnation is 700 μm or more, “Good” means a case where the depth of the impregnation is 400 μm or more and less than 700 μm, and “Bad” means a case where the depth of the impregnation is less than 400 μm.

### <Method for Evaluating Coating Film Conductivity>

2 cm×2 cm frames were prepared with pieces of tape on a glass plate whose surface was cleaned with isopropyl alcohol (IPA). 0.2 g Polymer Compositions 1 to 44 were dropped and uniformly spread on the inside of the respective frames. After the drying at 120° C. for 30 minutes, conductivity of each Polymer Composition was measured using Loresta GP manufactured by Mitsubishi Analytech.

### <Method for Evaluating Solution Resistance Value>

Electrode terminals of a digital multimeter (MT-4090) manufactured by Mother Tool Co., Ltd. were immersed in each of Polymer Compositions 1 to 46 or each of Gel Electrolytic Compositions 1 and 2, and the solution resistance value of each composition was measured.

Tables 2 and 3 show results of evaluating the corresponding solution stability, solvent solubility, impregnation property, coating film conductivity, solution resistance value of each of Polymer Compositions 1 to 44, and results of evaluating the corresponding solution resistance value of each of Polymer Compositions 45 and 46.

TABLE 2
Example

| | Polymer Composition | | | | | | | |
|---|---|---|---|---|---|---|---|---|
| | 1 | 2 | 3 | 4 | 5 | 6 | 7 | 8 |
| Solution Stability | Excellent | Excellent | Excellent | Excellent | Excellent | Excellent | Excellent | Excellent |
| Solvent Solubility | Excellent | Excellent | Excellent | Excellent | Excellent | Excellent | Excellent | Excellent |
| Impregnation | Excellent | Excellent | Excellent | Excellent | Excellent | Excellent | Excellent | Excellent |
| Property | | | | | | | | |
| Coating Film | O.L. | O.L. | O.L | O.L | O.L | O.L | O.L | O.L |
| Conductivity | | | | | | | | |
| (S/cm) | | | | | | | | |
| Solution Resistance | 150 | 10\hat{ }3 | 400 | 10\hat{ }3 | 200 | 10\hat{ }3 | 200 | 10\hat{ }3 |
| Value (kΩ) | | | | | | | | |
| | Polymer Composition | | | | | | | |
| | 9 | 10 | 11 | 12 | 13 | 14 | 15 | 16 |
| Solution Stability | Excellent | Excellent | Excellent | Excellent | Excellent | Excellent | Excellent | Excellent |
| Solvent Solubility | Excellent | Excellent | Excellent | Excellent | Excellent | Excellent | Excellent | Excellent |
| Impregnation | Excellent | Excellent | Excellent | Excellent | Excellent | Excellent | Excellent | Excellent |
| Property | | | | | | | | |
| Coating Film | 10\hat{ }−3 | O.L. | 10\hat{ }−3 | O.L. | 10\hat{ }−3 | O.L. | 10\hat{ }−4 | O.L |
| Conductivity | | | | | | | | |
| (S/cm) | | | | | | | | |
| Solution Resistance | 100 | 10\hat{ }3 | 300 | 10\hat{ }3 | 200 | 10\hat{ }3 | 300 | 10\hat{ }3 |
| Value (kΩ) | | | | | | | | |
| | Polymer Composition | | | | | | | |
| | 17 | 18 | 19 | 20 | 21 | 22 | 23 | 24 |
| Solution Stability | Excellent | Excellent | Excellent | Excellent | Excellent | Excellent | Excellent | Excellent |
| Solvent Solubility | Excellent | Excellent | Excellent | Excellent | Excellent | Excellent | Excellent | Excellent |
| Impregnation | Excellent | Excellent | Excellent | Excellent | Excellent | Excellent | Excellent | Excellent |
| Property | | | | | | | | |
| Coating Film | 10\hat{ }−3 | 10\hat{ }−3 | 10\hat{ }−3 | 10\hat{ }−3 | 10\hat{ }−3 | 10\hat{ }−4 | 10\hat{ }−4 | 10\hat{ }−4 |
| Conductivity | | | | | | | | |
| (S/cm) | | | | | | | | |
| Solution Resistance | 100 | 10\hat{ }3 | 200 | 10\hat{ }3 | 200 | 10\hat{ }3 | 300 | 10\hat{ }3 |
| Value (kΩ) | | | | | | | | |
| | Polymer Composition | | | | | | | |
| | 25 | 26 | 27 | 28 | 29 | 30 | 31 | 32 |
| Solution Stability | Excellent | Excellent | Excellent | Excellent | Excellent | Excellent | Excellent | Excellent |
| Solvent Solubility | Excellent | Excellent | Excellent | Excellent | Excellent | Excellent | Good | Good |
| Impregnation | Excellent | Excellent | Excellent | Excellent | Excellent | Excellent | Good | Good |
| Property | | | | | | | | |
| Coating Film | 0.5 | 0.3 | 0.5 | 0.4 | 0.6 | 0.2 | 0.5 | 0.4 |
| Conductivity | | | | | | | | |
| (S/cm) | | | | | | | | |
| Solution Resistance | 3 | 50 | 24 | 120 | 62 | 200 | 200 | 800 |
| Value (kΩ) | | | | | | | | |

TABLE 3
Comparative Example

Polymer Composition

| | 33 | 34 | 35 | 36 |
|---|---|---|---|---|
| Solution Stability | Bad | Bad | Excellent | Excellent |
| Solvent Solubility | Bad | Bad | Excellent | Excellent |
| Impregnation Property | Bad | Bad | Excellent | Excellent |
| Coating Film | O.L | O.L. | O.L. | O.L. |
| Conductivity | | | | |
| (S/cm) | | | | |
| Solution Resistance | O.L | O.L. | 5 × 10\hat{ }3 | 5 × 10\hat{ }3 |
| Value (kΩ) | | | | |

| | Polymer Composition | | | | | | | |
|---|---|---|---|---|---|---|---|---|
| | 37 | 38 | 39 | 40 | 41 | 42 | 43 | 44 |
| Solution Stability | Excellent | Excellent | Bad | Bad | Bad | Bad | Bad | Bad |
| Solvent Solubility | Bad | Bad | Bad | Bad | Bad | Bad | Bad | Bad |
| Impregnation Property | Bad | Bad | Bad | Bad | Bad | Bad | Bad | Bad |
| Coating Film | 0.5 | 0.3 | 200 | 100 | 150 | 50 | — | — |
| Conductivity | | | | | | | | |
| (S/cm) | | | | | | | | |
| Solution Resistance | 6 | 50 | 120 | — | 200 | 10\hat{ }3 | 200 | — |
| Value (kΩ) | | | | | | | | |

Polymer Composition

| | 45 | 46 |
|---|---|---|
| Solution Resistance | 35 | 600 |
| Value (kΩ) | | |

※O.L: Over Load

Tables 2 and 3 show that Polymer Compositions 1 to 32 exhibited satisfactory results in all of the solution stability, the solvent solubility and the impregnating property, while Polymer Compositions 33, 34 and 37 to 44 did not exhibit satisfactory results in all of the solution stability, the solvent solubility and the impregnation property. In addition, it was found that Polymer Compositions 35 and 36 exhibited satisfactory results in all of the solution stability, the solvent solubility and the impregnating property, while the solution resistance value of each of Polymer Compositions 35 and 36 was higher than that of each of Polymer Compositions 1 to 32.

Furthermore, it was found from Tables 2 and 3 that since the polymer composition of the present invention shows satisfactory results regarding the solvent solubility and the impregnating property, a particle diameter of a polymer thereof is small and highly dispersed.

Table 4 shows results of evaluating the respective solution resistance values of Gel Polymer Compositions 1 to 4.

TABLE 4

Gel Polymer
Composition

| | 1 | 2 |
|---|---|---|
| Solution Resistance | 200 | 2 × 10\hat{ }3 |
| Value (kΩ) | | |

It was found from Table 4 that the resistance value of Gel Polymer Composition 2 was higher than that of Gel Polymer Composition 1.

1. A polymer comprising one or two structural units selected from the group consisting of a structural unit represented by the following chemical formula (1): 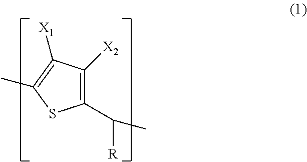
and a structural unit represented by the following chemical formula (2): 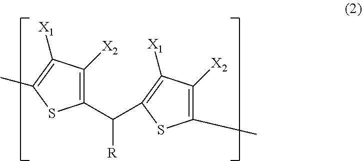
wherein X1 and X2 may be the same as or different from each other,
wherein X1 and X2 represent:
H;
an alkyl group having 1 to 12 carbon atoms, optionally having a substituent;
an alkoxy group having 1 to 12 carbon atoms, optionally having a substituent;
an alkylene oxide group having 1 to 12 carbon atoms, optionally having a substituent;
a thiocyano group optionally having a substituent;
an amino group optionally having a substituent; or
a thioalkyl group optionally having a substituent, or
X1 and X2 are combined to be an alkylenedioxy group having 1 to 12 carbon atoms, optionally having a substituent, or an alkylenedithio group having 1 to 12 carbon atoms, optionally having a substituent,
wherein X1 and X2 are not any of combinations of both X 1 and X 2 being H, of both X 1 and X 2 being the alkyl group having 1 to 12 carbon atoms, and of one of X 1 and X 2 being H with the other being the alkyl group having 1 to 12 carbon atoms, and
wherein R represents:
an alkyl group having 1 to 12 carbon atoms;
an alkoxy group having 1 to 12 carbon atoms;
an alkylene oxide group having 1 to 20 carbon atoms and 1 to 50 repeating units;
a phenyl group;
a heterocyclic group; or
a condensed ring group, having an acidic substituent or a salt thereof.

2. The polymer according to claim 1, wherein X1 and X2 may be the same as or different from each other, and
wherein X1 and X2 are:
the alkoxy group having 1 to 12 carbon atoms, optionally having the substituent; or
the alkylene oxide group having 1 to 12 carbon atoms, optionally having the substituent, or
X1 and X2 are combined to be the alkylenedioxy group having 1 to 12 carbon atoms, optionally having the substituent.

3. The polymer according to claim 1, wherein R is the alkyl group having 1 to 12 carbon atoms and the acidic substituent or the salt thereof, the alkoxy group having 1 to 12 carbon atoms, or the phenyl group.

4. The polymer according to claim 1, wherein the acidic substituent or the salt thereof is a sulfo group or an alkali metal salt thereof, or a phosphoric acid group or an alkali metal salt thereof.

5. An oxidized polymer being an oxide of the polymer according to claim 1.

6. A polymer composition comprising the polymer according to claim 1 and a solvent.

7. A polymer composition comprising the polymer composition according to claim 6 and a base additive.

8. A polymer composition obtained by drying the polymer composition according to claim 6.

9. A gel polymer composition obtained by adding a gelling agent to the polymer composition according to claim 6.

10. A polymer composition comprising the oxidized polymer according to claim 5 and a solvent.

11. A polymer composition comprising the polymer composition according to claim 10 and a base additive.

12. A polymer composition obtained by drying the polymer composition according to claim 10.

13. A gel polymer composition obtained by adding a gelling agent to the polymer composition according to claim 10.
